(19) United States
(12) Patent Application Publication
(10) Pub. No.: US 2026/0131499 A1
(43) Pub. Date: May 14, 2026

(54) PRESS MOLDING METHOD OF A FIBER PRODUCT, A FIBER PRESS MOULD AND A FIBER PRODUCT

(71) Applicant: BLUE OCEAN CLOSURES AB, Karlstad (SE)

(72) Inventor: Lars Sandberg, Hammarö (SE)

(73) Assignee: BLUE OCEAN CLOSURES AB, Karlstad (SE)

(21) Appl. No.: 19/114,291

(22) PCT Filed: Sep. 11, 2023
(86) PCT No.: PCT/EP2023/074850

§ 371 Date: Mar. 21, 2025

(30) Foreign Application Priority Data
Sep. 23, 2022 (SE) 2251100-0

(51) Int. Cl. B27N 3/20; B27N 5/02; B30B 9/28; B30B 15/06

(52) U.S. Cl. CPC B27N 3/203; B27N 5/02; B30B 9/28; B30B 15/062; B30B 15/065

(57) ABSTRACT

This invention relates to a press molding method of a fiber product, at high pressure and high temperature, by means of a press pad device (2) and a stamp device (3,4), wherein said fiber product (1) comprises a bottom part (11) and an edge part (10), characterized by said stamp device (3,4) comprising two stamp members (3,4), wherein a first stamp member (3) forms at least said bottom part (11) and a second stamp member (4) forms said edge part (10), wherein also comprising a gasket member (5) applied to a bottom portion (33) of stamp device (3), wherein said gasket member (5) forms an inner part on top said bottom part (11) and a second stamp member (4) may form said edge part (10). This invention also relates to fiber press mould (2,3,4) and a fiber product (1).

### TECHNICAL FIELD

This invention relates to a press molding method of a fiber product, at high pressure and high temperature, by means of a press pad device and a stamp device, wherein said fiber product comprises a bottom part and an edge part and a fiber press mould for performing the method.

### TECHNICAL BACKGROUND

A fiber product can be made by pressing a web or a sheet of fibers. Typically, a combination of natural fibers (e.g. wood pulp fibers), synthetic fibers (e.g. polyolefin-based fibers, such as fibers made from polyethylene) and other additives such as binder or dye. In many applications it is preferred that such a web essentially merely comprises of natural fiber, with or without additives. Typical process conditions are 150-250° C. and pressures 100-10000 bar (200-2000 Bar). Moisture content may typically be less than 20%.

The fiber product can be in the form of a hollow product, for example a package or a closure (lid, screw cap or similar), but can also be a flat product. Products can be formed from a web of the material and punched/cut in connection with forming, e.g. that have been completely or partially separated from the web to allow deeper shaping. This exposure is typically done by cutting the material into a shape that is adapted to the final shape. Typically, for example, a roundel is cut to form a round package.

The press molding typically takes place with two tools where both the outer tool pad and the inner tool (stamp) can consist of several parts to enable discharge of the finished product. Typically, the pad opens while the stamp collapses. The piston, parts of the piston or parts of the pad can also be made of a compressible material which enables greater vertical compressive forces, typically against the sides of the cavity, by the tool material being reshaped during the compression.

Examples of known methods described above are shown in EP 3 736 099 and WO 2020/165780.

There exist disadvantages of known methods. Accordingly, there is a need for improvements.

### SUMMARY OF THE INVENTION

It is an object of the invention to eliminate or at least minimize disadvantages which exist with known prior art. By means of a method as defined in claim 1 and/or a fiber press mould as defined in claim 17, improvements are achieved.

Thanks to the invention an improved release of the product from the pressing tools may be achieved. Further the invention may provide products with improved sealing properties. Moreover, the invention may beneficially maintain surface structures of the stamp device, by facilitating the provision of a kind of protective cover that may eliminate/minimize wear of stamp surface/s.

Cutting after press molding may be completely avoided. In addition to eliminate the need of further cutting and eliminating a need of taking care of leftovers, the invention may also achieve a better product in that the quality of the edge of product may be more or less tailored, e.g. providing a higher quality in the edge portion.

### DESCRIPTION OF FIGURES

In the following, the present invention will be described with reference to FIGS. 4, 5, 6 and 7 wherein a preferred embodiment of a schematic pressing mould and method according to the present invention is shown by schematically describing the manufacture of an exemplary product. Further it is also referred to FIG. 1-3 which relate to a specific preferred example of a further invention, in which:

FIG. 1 shows a schematic cross-sectional view of a press mould in a first stage of producing a cup shaped cylindrical fiber product,

FIG. 2 shows a schematic cross-sectional view of a press mould in a second stage of producing a cup shaped cylindrical fiber product,

FIG. 3 Shows the same schematic cross-sectional view as FIG. 2, but with a pressing mould arranged with grooves for cup shaped cylindrical fiber product having threads, of the other invention, and,

FIGS. 4-7, show sequentially the principles of the new invention.

### DETAILED DESCRIPTION

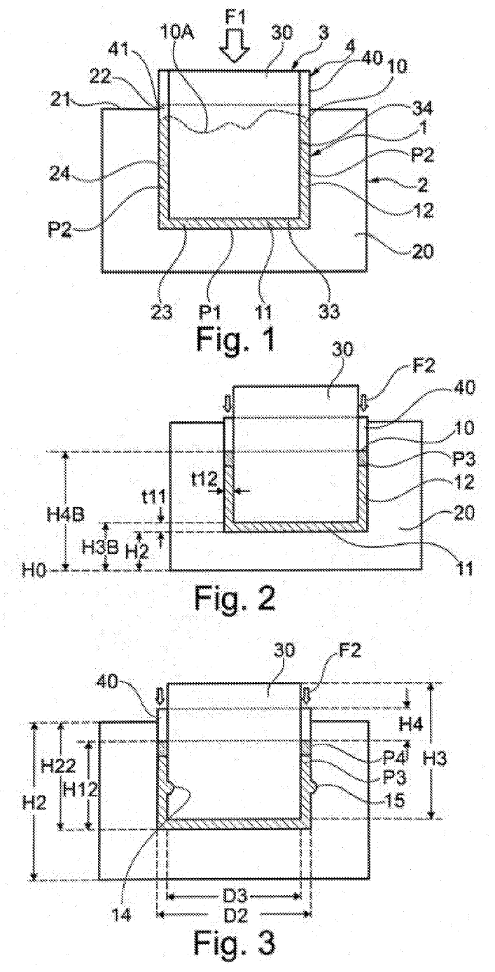

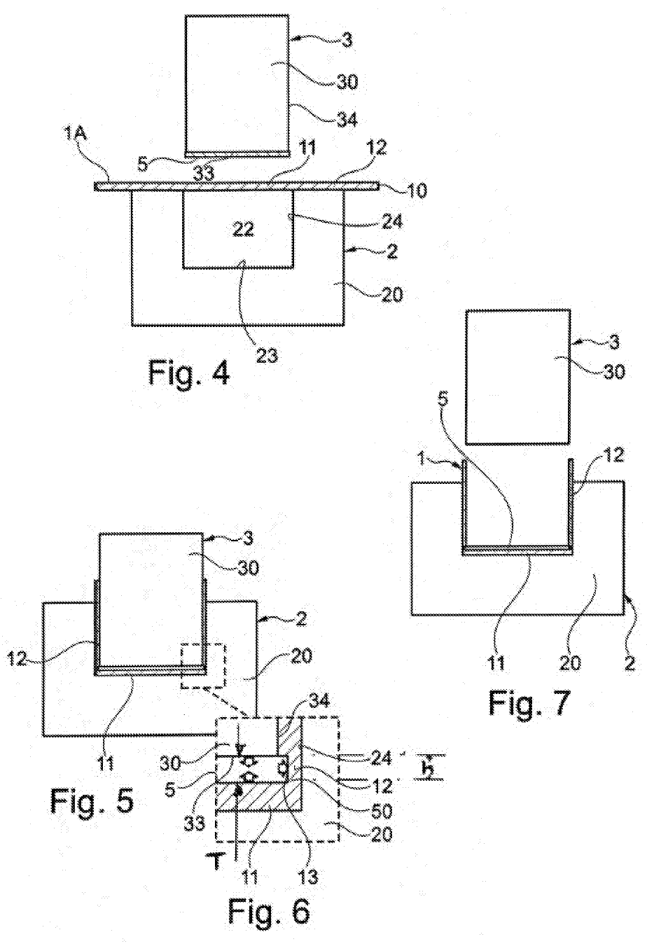

In FIGS. 1, 2 and 3 there is shown a fiber press mould, comprising a press pad device 2 and a stamp device 3, for forming a fiber product 1, according to an inventive method already filed in an earlier patent application, which may be combined with the new invention described in relation to FIGS. 4-7.

The stamp device may comprises two stamp members 3, 4, wherein a first stamp member 3 is arranged to form at least a bottom part 11 of said fiber product 1 and a second stamp member 4 is arranged to form the edge part 10 of said fiber product. In the shown embodiment the second stamp member 4 is movable along the outer periphery of said first stamp member 3.

The press pad device 2 comprises a body 20, having a total height H2. The press pad device 2 is arranged with a cavity 22. In this embodiment the cavity is relatively large in order to enable a cup shaped fiber product 1, i.e. comprising side walls 12 between the edge part 10 and the bottom part 11. Hence the cavity 22 comprises a bottom surface 23 and sidewalls 24, which in this embodiment is formed by a ring shaped, cylindrical surface. The total height H22 of the cavity 22, i.e. from the bottom surface 23 of the cavity to the upper surface 21 of the body 20, is arranged such that it is larger than the height H12 of the fiber product 1. Preferably H2 is at least 10% larger than H12, more preferred at least 15% larger.

The first stamp member 3 comprises a body 30 adapted to fit into the cavity 22 such that a gap may be formed between the side surface 34 thereof and the sidewalls 24 of the cavity, whereby a desired thickness t12 of the side walls 12 of the fiber product may be achieved. This is achieved by having a cross-sectional measure D2 of the cavity 22 that is two times t12 larger than the cross-sectional measure D3 of the first stamp member 3, i.e. D2=D3+2 t12. In the shown embodiment, where a product 1 with circular form is produced, this is achieved by using a circular shape of the side walls 24, 34 forming the cross-sectional measures in the form of diameters D2 and D3, respectively. As is understood by the skilled person, other shapes than exactly circular may of course be used, e.g. merely along the side walls 24 of the of the press pad device 2. The second stamp member 4 has a ring-shaped body 40 arranged to slide along the outer surface 34 of the first stamp member 3 and may have a height H4 that is smaller than the height H3 of the first stamp member 3. An end surface 41 of the ring-shaped body 40 will be forming the edge part 10 of the fiber product 1.

When using the mould for press molding of the fiber product 1, a pre-cut blank (not shown per se) is introduced into the cavity 22 of the press pad device 2. The height H22 of the cavity 22 is such that the entire pre-cut blank may be positioned within the cavity 22, i.e. such that no parts of the pre-cut blank protrude above the upper surface 21 of the press pad device 2.

In a first step the first stamp member 3 is applied with a force F1 to move down into the cavity 22 and will then form an intermediate product 1 having an uneven upper edge 10A, see FIG. 1.

The force F1 may produce a higher pressure P1 within the bottom part 11 than the pressure P2 within the edge part.

The height H22 of the cavity 22 is such that all parts of the uneven upper edge 10A is positioned below the upper surface 21 of the press pad device 2. Subsequently the second stamp member 4 is applied with a force F2 to move along the outer side surface 34 of the first stamp member 3, to be forced down into the cavity 22 in the gap formed between the outer side surface 34 of the first stamp member 3 and the walls 24 of the cavity. High temperature is used during production and high pressure is applied by means of the press pad device 2 and the stamp device 3,4, to form the fiber product 1. The molding temperature may be in the range of 150-250° C. and the applied pressure by the stamps 3, 4 is at least 200 bar. In some applications it is preferable to use a force F2 that will produce a higher pressure P3, at least partly, within the side walls 12 of the product than the pressure P2 that is produced by the force F1 applied to the first stamp member 3.

As is shown, the first stamp member 3 forms at least the bottom part 11 of the fiber product 1 and the second stamp member 4 forms the edge part 10. This basic principle may also be used on a flat shaped fiber product. Preferably the first stamp member 3 at least partly forms at least said bottom part 11 before said second stamp member 4 starts forming said edge part 10.

Preferably the arrangement is such (e.g. sensor controlled) that the first stamp member 3 stops pressing at a given distance H3B in relation to a position HO of the press pad device 2 and the second stamp member 4 stops pressing at a given distance H4B in relation to that position HO of the press pad device 2. Of course, this latter position may also be set in relation to the first stamp member 3. Most preferred the end position of the first stamp member 3 is such that pressing stops at a given distance H4B in relation to a position HO of said press pad device 2 such that a given thickness t11 is achieved for said bottom part 11.

As shown in the figures the fiber product 1 may comprise sidewalls 12 wherein the second stamp member 4 stops at a given distance H4B, at a set distant H12 from said bottom part 11, such that the edge part 10 is positioned such that a desired height H12 of the product 1 is achieved. As already mentioned above the second stamp member 4 may be applied with a force F2 producing a pressure P3 within the upper edge part 10 that differs from pressure P2 produced by the first stamp member 3, which may provide advantages. In many applications it may be an advantage that the second stamp member 4, is applied to produce a higher pressure P3 than the pressure P2 exerted from the first stamp member 3. This may be especially advantageous if the edge part 10 is to be given a pattern or a profile, and/or if the portions of the side walls 12, below the edge part 10, is to be given a pattern or a profile, e.g. protruding profiles inwardly 14 and/or outwardly 15, e.g. forming threads and/or a rim as indicated in FIG. 3.

Further, as indicated in FIG. 3 the force F2 applied by the second stamp member 4 may achieve a higher pressure P4 near the edge part 10 than the pressure P3 achieved further down within the side walls 12, below the edge part 10, due to resilient properties of the fibers.

Thanks to the invention described in relation to FIGS. 1-3, a great flexibility is provided regarding production of fibre products, e.g. to achieve a higher density in the edge part 10 than in the bottom part 11. A higher local density at the edge part may reduce the ability for penetration of moisture and liquid. Further it facilitates easy production of an edge part having a desired appearance, e.g. straight even faces. Moreover, it facilitates easy production of side walls arranged with protruding members, e.g. threads and/or ribs, etc. the material consists partly of natural fibers, A.

Preferably the fiber material in the fiber product 1 is in the form of natural fibers from wood. Further, the amount of water in pre-cut blank (e.g. roundel) prior to pressing shall not exceed 20% the weight of fiber.

Further, by designing the mould tool so that an entire pre-cut blank may be pressed down into the pad 2 and below the upper end surface of the pad 2 and the form the upper edge part 11, a product with a given height and volume of material may be created. The secondary pressing may achieve the desired result despite having fibers that have been relocated during the pressing with the first stamp member 3. Hence, the final product may successfully be achieved despite slightly varying density in the upper edge part 11 without any problems regarding creasing and/or local differences in the upper edge of the preformed product. In particular, the post-forming can beneficially compress side walls of a cup shaped product, by applying a relatively small force P2 onto a limited horizontal surface compared to the force P1, that is applied by means of said stamp member 3. The second stamp member can be seen as creating a kind of reshaping, which may also assist in shaping inward or outward formations with a varying gap thickness or shape such as, for example, embossments, stiffeners or threads as in FIG. 3.

An additional benefit is that by means of the invention described in relation to FIGS. 1-3, the shaping of faces having precise patterns or profiles may be achieved, i.e. shapes that are not possible to achieve if cutting is needed to shape the final product.

According to a modification of the invention (not shown) described in relation to FIGS. 1-3, the second stamp member 4 can be arranged to cut off a non-desired part (not shown) of the final fiber product 1, e.g. at a given distance from said bottom part. Preferably this is performed such that first the pressing edge 41 of the second stamp 4 first compresses the edge 10, at least partly, and that a cutting edge (not shown) of the second stamp in a final step both finally compresses the edge 10 and cuts off a non-desired surplus.

Now turning to the present invention described in relation to FIGS. 4-7.

In the figures there is shown a pad device 2, a stamp device 3 with a gasket member 5 and a blank 1. The gasket member 5 is releasably applied to lower face 33 of stamp device 3. In FIG. 4 it is shown at a stage prior to forming of a product, i.e. prior to pushing the formable material 11, 12 of the blank 1 into the cavity 22 of the pad device 2, to form a bottom 11 and side walls 12. The stamp and the pad are predominantly stiff materials. The formable material of the blank 1 is typically a compressible material that normally retains its shape after being compressed and released from pressure. The gasket member 5 is sheet formed made of a compressible and at least partly plastically formable material, which has the characteristic that the volume thereof is mainly retained when being compressed. Generally the gasket has peripheral edges extending radially, preferably having a thickness less than 3 mm.

In FIG. 5 it is shown that pressure is applied, such that the stamp device 3 and pad device are moved together, and a pressure is applied to the materials 5, 11, 12 in-between the two entities. This pressure will compress and form the formable material 11, 12 of the blank 1 and compress and deform the compressible material of the gasket member 5. The deformation of the gasket member 5 will result in an axial compression and a radial expansion, whereby the peripheral edges 50 of gasket member 5 will move radially and create a recess 13 in the formable material of the blank 1. After the compression the gasket member 5 is released from the stamp device 3 and will thereby assist in holding the formed product 11, 12 in place in the cavity 22 after pressure is released and form an inner part on top of the bottom part 11 of the product. The gasket member 5 may provide a function of the formed product, for example as a gasket providing improved sealing properties. However, it may also be used merely to assist in proper release of the product from the stamp 3. The gasket member may follow the formed fiber material (in close proximity) when leaving the stamp device or it may remain with the stamp device after forming the formed fiber material and it is released therefrom. In other words, said gasket member (5) may either follow the fiber product attached to it, when forming has been completed, or said gasket member may remain with the stamp device (3), when the formed fiber product leaves said devices.

In any case, the material of gasket member 5, used to transmit an isostatic pressure from the stamp device 3 may remain with the formed item. This may be of great advantage when instead of using soft, easily formed material such as polymers for closures using more brittle materials, e.g. cellulosic fibers. When using polymers, the dent holding a gasket can be formed by a mainly stiff stamp since the stamp can then easily be removed from the cavity due the soft and flexible nature of polymers. When using a formable material that has a stiffer and/or more brittle nature, for example cellulosic fibers, it may not possible of geometry and stiffness reasons to pull the formed object from the stamp device 3 without breaking it.

In one application the formable material and resulting formed item may preferably be partly consisting of natural fibers, preferably natural fibers from wood. Said material may further preferably consist of (partly or mainly) cellulosic fibers. These fibers may have its origin from natural sources, preferably natural wood fibers, straw (such as bagasse) and re-cycled wood fibers, or a combination thereof, most preferred natural wood fibers as said above, especially preferred virgin natural wood fibers, and if sustainability is of importance, re-cycled wood fibers may be preferred.

In one application the Compressible material is made from a polymer with or without entrapped gas bubbles.

In one application the Compressible material is softened or melted from the heat in the forming operation.

In one application the Compressible material contain wood fibers

In one application the formed product/object is a closure.

In one application the compressible material in the gasket member is a top seal liner.

Also provided in the present application is a fiber product obtainable by the method according to claim 1 above or according to any one of the preferred embodiments mentioned above.

1. Press molding method of a fiber product, comprising applying high pressure and high temperature to a blank (1), by means of a press pad device (2) and a stamp device (3), thereby forming a fiber product (11, 12) comprising a bottom part (11) and side walls (12), characterized by applying a sheet shaped gasket member (5) to a bottom portion (33) of said stamp device (3), said gasket member (5) forming an imprint in said side walls (12), above an inner surface of said bottom part (11).

2. Press molding method according to claim 1, providing said sheet shaped gasket member (5) to be at least partly elastic and preferably compressible.

3. Press molding method according to claim 1, wherein said gasket member (5) during pressing is expanded laterally beyond a side surface (34) of said stamp (3) to have the peripheral sheet edge (50) of said gasket member (5) protruding into a part (12) of said fiber product (1) forming a recess (13) in said fiber product (1).

4. Press molding method according to claim 1, wherein an end position of the stamp device (3) stops pressing at a given distance (H3B) in relation to a position (H0) of said press pad device (2) so that a given thickness (t11) is reached for said bottom part (11).

5. Press molding method according to claim 1, wherein an additional stamp device (4) presses an edge part (10).

6. Press molding method according to claim 5, wherein said additional stamp device (4) is a separate member that stops pressing at a given distance (H4B) in relation to a position (H0) of said press pad device (2) and/or said stamp device (3).

7. Press molding method according to claim 6, wherein said additional stamp device (4) is movable along an outer periphery of said stamp device (3).

8. Press molding method according to claim 1, wherein forces (F1, F2) are applied to the stamp device (3) and an additional stamp device (4), such that different pressures (P2, P3) are achieved within edge part (10) when pressing with the stamp device (3) compared to when also pressing with the additional stamp device (4), wherein preferably a higher pressure (P3) is achieved when pressing with the additional stamp device (4).

9. Press molding method according to claim 1, wherein said fiber product comprises partly of natural fibers, preferably natural fibers from wood.

10. Press molding method according to claim 1, wherein the temperature is 150-250° C. and the pressure on said bottom part (11) is at least 200 bar.

11. Press molding method according to claim 1, wherein the amount of water in the material does not exceed the amount of fiber, wherein preferably the weight of water in the material does not exceed 20% the weight of fiber.

12. Press molding method according to claim 1, wherein said edge part (10) and/or side walls (12) is/are given a pattern and/or a profile (14, 15).

13. Press molding method according to claim 1 wherein said sheet formed gasket member (5) is left with said fibre product (1), when forming has been completed.

14. Press molding method according to claim 1, wherein said sheet formed gasket member (5) remains on said press device (3), when forming has been completed, and preferably a separate gasket member in a later stage is positioned in said fibre product (1).

15. A fiber product obtainable by the method according to claim 1.

16. A fiber press mould, comprising a press pad device (2) and a stamp device (3,4), arranged to form a fiber product (1) comprising a bottom part (11) and an edge part (10), characterized in that said stamp device (3) comprises a releasable sheet formed gasket member (5) applied to a bottom portion (33) of said stamp device (3) wherein said gasket member (5) forms an inner part on top said bottom part (11) of the formed fiber product (1).

17. A fiber press mould according to claim 16, wherein said sheet formed gasket member (5) at least partly is elastic and preferably compressible.

18. A fibre product comprising a bottom part (11), side walls (12) and an edge part (10), characterized in that a sheet formed gasket member (5) forms an inner part on top of said bottom part (11) of the formed fibre product (1).
